(19) United States
(12) Patent Application Publication
(10) Pub. No.: US 2026/0337436 A1
(43) Pub. Date: Oct. 29, 2026

(54) A COATED SOLID CELLULOSE FOAM MATERIAL

(71) Applicant: Stora Enso OYJ, Helsinki (FI)

(72) Inventor: Daniel Hult Torron, Täby (SE)

(73) Assignee: Stora Enso OYJ, Helsinki (FI)

(21) Appl. No.: 19/112,332

(22) PCT Filed: Sep. 22, 2023
(86) PCT No.: PCT/IB2023/059382

§ 371 Date: Mar. 17, 2025

(30) Foreign Application Priority Data
Sep. 23, 2022 (SE) 2230310-1

(51) Int. Cl. C09D 101/02; C08B 15/00

(52) U.S. Cl. CPC C09D 101/02; C08B 15/00

(57) ABSTRACT

The present invention relates to a coated cellulose foam material having a density in the range of from 10 to 80 kg/m3, and a method for coating a cellulose foam. Said coated cellulose foam material is formed by applying at least one coating layer of at least one coating composition on at least one outer surface of a cellulose foam.

### FIELD OF THE INVENTION

The present invention relates to a coated solid cellulose foam material and a method for coating a cellulose foam that is at least partially dry.

### BACKGROUND

Different porous materials, such as foams, are commonly used in applications such as insulation in buildings and airplanes and as packaging materials that are used to protect various goods during storage and transportation.

Depending on the item to be protected, different types of protective packaging materials can be used. For many items, a low-weight cushioning material that reduces impact shock and vibrations is used. Common examples of such cushioning material are petroleum-based polymer foams such as polyurethane, polyethylene and expanded polystyrene. The foams used should be low-weight, stable and easy to manufacture.

Today, there is an increasing interest in replacing petroleum-based polymers with polymers from renewable resources, i.e. biobased polymers. Cellulose is the most abundant renewable natural polymer on earth and is therefore of special interest. For a cellulose foam recycling of the material in regular recycling streams may be possible, depending on the composition of the foam.

There are several examples of cellulose foams, prepared using different methods. Drying the wet foam composition is typically a critical step. Since the stability of the wet foam is typically low, moulds are commonly used to prevent the foam from collapsing during drying. WO20200011587 A1 describes a porous material that is prepared by aerating a paste comprising cellulose fibres and gluten and depositing the aerated paste in a mould where it is dried. The dried porous material has the shape of the mould. WO2015036659 A1 describes a moulded fibrous product prepared by foaming an aqueous suspension of natural fibres in combination with synthetic fibres and surfactant, feeding the fibrous foam to a mould and drying the foam by first mechanically withdrawing a part of the water followed by evaporating water to produce a dry fibrous product.

To enable a more versatile and efficient processing, foams that are dimensionally stable already in the wet state are desired.

When replacing foams from petroleum-based polymers with e.g. cellulose foams, there are a number of challenges related to manufacturing processes that must be overcome.

For commercially available foams made from petroleum-based polymers, automated foam production and packaging lines use two main means of lifting and moving products, namely pins and vacuum suction. The former entails a movable arm having several metal pins that can be inserted into the foam at an angle, allowing the machine to lift the foam. The pin process leaves small holes in the product, where size depends on the gauge thickness of the pin. The pins need to be sufficiently thick as to not risk breaking, leaving behind metal residue inside the product. Another common method for lifting is vacuum suction, whereby suction cups are pressed against the surface of the foam and air is evacuated. This process relies heavily on having a low air permeable surface in order to generate a vacuum suction and sufficient lift. Furthermore, certain converting equipment such as plotting tables rely on vacuum from below to hold samples in place while cutting. In these applications it is highly important that the samples do not move since this will break the oscillating blade.

Since cellulose foams generally have a high air permeability due to the porous structure of the foam, it is not possible to use vacuum lifting or fixating equipment during production and converting operations.

Another drawback with cellulose foams is that the surface characteristics of the foam in terms of smoothness does not compare to conventional paper making, where the material is pressed to generate a very smooth surface. The surface texture of the cellulose foam is obtained by the self-consolidation of fibres upon drying. Furthermore, the low-density and porous nature of the cellulose foam presents plenty of capillary action for water to diffuse into, leading to ink bleeding when printing and a lower fidelity print as a result. Lastly, the high moisture uptake of the cellulose foam due to its fibrous and porous nature can present difficulties to deal with condensation of water when used in thermal packaging of frozen goods.

Thus, there is still need for a biobased foam that is recyclable and that also enables use of automated processes including vacuum lifting and fixating equipment. To facilitate efficient manufacturing of the foam, particularly in terms of drying, it is desired that the foam is dimensionally stable also in the wet state.

In addition, it is also desired that the surface characteristics, such as surface gloss, smoothness, ink absorbency and hydrophobicity of the biobased foam can be tailored.

### SUMMARY OF THE INVENTION

It is an object of the present invention to provide an improved solid cellulose foam, which foam is recyclable and made from renewable sources, and which eliminates or alleviates at least some of the disadvantages of the prior art materials.

It is a further object of the present invention to provide a solid cellulose foam that can be used in processes involving vacuum lifting and fixating equipment.

It is a further object of the present invention to provide a solid cellulose foam which enables tailormade surface characteristics depending on the use of the solid cellulose foam.

It is a further object of the present invention to provide a solid cellulose foam that can be produced by drying a wet foam without use of a mould to enable versatile production methods.

The above-mentioned objects, as well as other objects as will be realized by the skilled person in light of the present disclosure, are achieved by the various aspects of the present disclosure.

According to a first aspect, the present invention relates to a coated solid cellulose foam material having a density in the range of from 10 to 80 kg/m³; wherein the coated cellulose foam material comprises a solid cellulose foam having at least one coating on at least one outer surface, and wherein the at least one coating comprises at least one coating layer.

It has surprisingly been found that by applying a coating to at least one outer surface of the cellulose foam, the air permeability of the solid cellulose foam is decreased so that processes using vacuum lifting and fixating equipment can be used. This facilitates processing of the foam, particularly in terms of operations used when converting the foam for use in different packaging applications. The type of applied coating can further be selected so as to provide the solid cellulose foam with not only a decrease in air permeability, but also other desired properties such as surface smoothness, ink absorbency, hydrophobicity, resistance to scratching and surface gloss. The surface properties of the solid cellulose foam can be tailored depending on the end use of the foam by application of one or several coatings.

The cellulose foam preferably comprises in the range of from 71 to 95 wt % cellulose fibres, as calculated on the total weight of solid content in the foam, in the range of from 4 to 24 wt % of a water-soluble thickener, as calculated on the total weight of solid content in the foam, and at least two surfactants. A wet foam having such a composition will be free-standing and does not require a mould or any other forming means to retain its shape during drying.

According to a second aspect, the present invention relates to a method for coating a cellulose foam, the method comprising the following steps:
a) providing a cellulose foam comprising at least one outer surface, and wherein the at least one outer surface is at least partially dry;
b) providing at least one coating composition;
c) applying at least one coating layer of the at least one coating composition to at least one outer surface of the cellulose foam so as to obtain a coated cellulose foam material;
d) drying the coated cellulose foam material so as to obtain a coated solid cellulose foam material having a density in the range of from 10 to 80 kg/m³.

It has surprisingly been found that the coating layer can be applied to a cellulose foam that is at least partially dried. This enables a versatile processing method, where properties of the cellulose foam can be tailored by application of a certain coating. Since the coating can be applied to an at least partially dried foam, it is also possible to influence properties of the cellulose foam during processing. The coated solid cellulose foam material according to the first aspect may be produced by the method according to the second aspect.

According to a third aspect, the present invention relates to use of the coated solid cellulose foam material according to the first aspect in a packaging, as insulating material, or as a building material.

### DETAILED DESCRIPTION

The term “foam”, as used herein, refers to a substance made by trapping air or gas bubbles inside a solid or liquid. Typically, the volume of gas is much larger than that of the liquid or solid, with thin films separating gas pockets. Three requirements must be met in order for foam to form. Mechanical work is needed to increase the surface area. This can occur by agitation, dispersing a large volume of gas into a liquid, or injecting a gas into a liquid. The second requirement is that a foam forming agent, typically an amphiphilic substance, a surfactant or surface active component, must be present to decrease surface tension. Finally, the foam must form more quickly than it breaks down.

The term “cellulose foam”, as used herein, refers to a foam comprising cellulose, and other components such as thickeners, surfactants and additives. The main component of the cellulose foam is cellulose, such that cellulose constitutes at least 70 wt % of the dry content of the cellulose foam. Cellulose is in the form of fibres, and the foam can thus also be defined to be a fibrous foam or a cellulose fibre foam. The cellulose foam may be wet or solid.

The term “wet foam”, or “wet cellulose foam”, as used herein, refers to a wet foam comprising cellulose, and other components such as thickeners, surfactants and additives. Gas bubbles are present within the wet foam. The wet foam is freestanding and behaves as a viscoelastic solid. This means that the wet foam has both viscous and elastic properties. The wet foam will behave as a solid, and thus be freestanding, unless a large enough force is applied so that it starts to flow and instead behave as a viscous material. Depending on the magnitude and timescale of any applied shear stress, the wet foam can show a predominantly viscous or elastic behaviour.

The term “solid cellulose foam”, or “dry cellulose foam”, as used herein, refers to a dry porous cellulose material that has been formed from a wet cellulose foam, i.e. a foam formed material. During the drying process, a closed wet cellulose foam is transformed into an open solid cellulose foam. The network of cellulose fibres is prevented from collapsing during drying. The solid cellulose foam will as a result have a shape that to a large extent corresponds to that of the wet cellulose foam. The dry content of the solid cellulose foam is at least 95 wt % as calculated based on the total weight of the solid cellulose foam. The shape and density of the solid cellulose foam is retained also in a non-confined state. The solid cellulose foam has an open cell structure, allowing air to occupy the pores within the foam.

The solid cellulose foam can also be described as a porous material or a low-density material.

The first aspect of the present invention relates to a coated solid cellulose foam material. The coated solid cellulose foam material is dry and may have a solid content in the range of from 95 to 100 wt %, preferably from 98 to 100 wt %, as calculated on the total weight of the coated solid cellulose foam material. The coated solid cellulose foam material has a density in the range of from 10 to 80 kg/m³, preferably from 10 to 60 kg/m³ and more preferably from 20 to 50 kg/m³.

The coated solid cellulose foam material is prepared by applying at least one coating to at least one outer surface of a cellulose foam. The cellulose foam is preferably solid and may have a density in the range of from 10 to 80 kg/m³, preferably from 20 to 50 kg/m³ and more preferably from 20 to 50 kg/m³. The applied coating layer is thin and thus has a negligent influence on the density of the coated solid cellulose foam material.

The cellulose foam preferably comprises cellulose fibres, in a range from 71 to 95 wt %, such as from 75 to 95 wt %, based on the total dry weight of the cellulose foam. Cellulose fibres suitable for use in the present invention can originate from wood, such as softwood or hardwood, from leaves or from fibre crops (including cotton, flax and hemp). The cellulose fibres suitable for use in the present invention can also originate from regenerated cellulose such as rayon and Lyocell. The cellulose fibres suitable for use in the present invention may include lignin or hemicellulose or both, or the cellulose fibres may be free from lignin and hemicellulose. Preferably, the cellulose fibres originate from wood, more preferably the cellulose fibres are pulp fibres obtained by pulping processes which liberates the fibres from the wood matrix. Pulp fibres can be liberated by mechanical pulping, obtaining mechanical pulp such as thermos mechanical pulp (TMP) or chemo thermos mechanical pulp (CTMP), or by chemical pulping such as Kraft pulp or pulps obtained by the sulphite process, soda process or organosolv pulping process. More preferably, the cellulose fibres are pulp fibres liberated by chemical pulping processes. The different characteristic of each cellulose fibre will affect the properties of the final cellulose foam. A cellulose fibre is significantly longer than it is wide. Cellulose fibres can have a mean width of 0.01 to 0.05 mm. The fibre length of softwood can be from 2.5 to 4.5 mm, while hardwood can have a fibre length from 0.7 to 1.6 mm, and Eucalyptus from 0.7 to 1.5 mm. However, the fibre length can vary considerably with different growing place etc. The cellulose fibres in the cellulose foam disclosed herein can have a length from 0.1 mm to 65 mm, or from 0.1 mm to 10 mm, or from 0.5 mm to 65 mm, or from 0.5 mm to 10 mm, or from 0.5 mm to 7 mm. The fibre lengths may provide different mechanical characteristics to the foam. Due to the length of fibres, they can entangle with each other and impart fibre to fibre interbonds that bring strength to the foam. The aspect ratio, i.e. the ratio of the fibre length to the fibre width, of the cellulose fibres in the cellulose foam according to the present invention can be at least 10, at least 25, at least 50, at least 75, or at least 100, which provides for preservation and stabilization of the foam structure during the drying procedure, making it possible to dry the wet cellulose foam with retained shape. The aspect ratio can be up to 6500, or preferably up to 2000.

The cellulose fibres may be modified to provide different properties to the final cellulose foam. For example, phosphorylated fibres or periodate oxidized fibres could also be used when producing a cellulose foam according to the present invention.

Preferably, the cellulose fibres are selected from wood pulp, such as softwood Kraft bleached pulp, hardwood pulp, chemical-thermomechanical pulp, and from dissolving pulp, or a combination of one or more of these. More preferably the cellulose pulp fibres are from softwood pulp, chemical-thermomechanical pulp, or dissolving pulp. Most preferably the cellulose pulp fibres are from softwood pulp, such as softwood Kraft bleached pulp.

The cellulose foam preferably comprises cellulose fibres in a range of from 71 to 95 wt %, such as from 75 to 95 wt %, based on the total dry weight of the cellulose foam, a water-soluble thickener in a range of from 4 to 24 wt %, such as from 5 to 20 wt %, based on the total dry weight of the cellulose foam, and at least two surfactants.

The water-soluble thickener may have a molecular weight of from 80 000-250 000 g/mol, or from 83 000-197 000 g/mol. Exemplary water-soluble thickeners are selected from carboxy methyl cellulose (CMC), methyl cellulose (MC), hydroxyethyl cellulose (HEC), ethyl hydroxyethyl cellulose (EHEC), methyl hydroxypropyl cellulose (MHPC), starch, xanthan, guar gum, and xyloglucan, or mixtures thereof. The fact that the thickener is water-soluble facilitates recycling of the cellulose foam.

The water-soluble thickener may improve the fibre-fibre bonding strength, primarily through hydrogen bonding, in the cellulose foam, Therefore, the amount of water-soluble thickener will influence the mechanical performance of the cellulose foam, and especially the bulk of the material. A higher content of water-soluble thickener provides for a stiffer material. Thus, the water-soluble thickener enables tailoring of the mechanical properties of the cellulose foam.

The cellulose foam may also comprise a mixture of at least two surfactants. One of the at least two surfactants is preferably a fast-acting surfactant, a suitable surfactant for this purpose is an anionic surfactant, preferably a low-molecular weight anionic surfactant. The anionic surfactant may have an apparent pKa of from 3.2 to 3.8, preferably from 3.4 to 3.6, or an apparent pKa of 3.5 in a solution having a pH of from 7 to 9, preferably a pH of 8. The low-molecular weight anionic surfactant may be selected from sodium dodecyl sulphate (SDS); potassium dodecyl sulphate, sodium laureth sulphate (SLES); sodium dodecylbenzenesulphonate; sodium cocoyl sarcosinate; sodium lauroyl sarcosinate. The low-molecular weight anionic surfactant is preferably selected from sodium dodecyl sulphate (SDS); sodium p-n-dodecylbenzenesulphonate; sodium cocoyl sarcosinate; and sodium lauroyl sarcosinate. More preferably the low-molecular weight anionic surfactant is sodium cocoyl sarcosinate. The anionic surfactant may be biodegradable.

The other one of the at least two surfactants is preferably a co-surfactant. The co-surfactant may be selected from the group comprising surfactants having an apparent pKa of at least 8, or at least 9, in a surfactant solution having pH of from 7 to 9, preferably having a pH of 8; and amphoteric betaines. The co-surfactant may have maximum apparent pKa of 10. The co-surfactant preferably has a long carbon chain, more preferably a carbon chain with 14 carbon atoms (C14). The co-surfactant may be selected from high pKa fatty acids, such as from plant derived feedstock, e.g. tetradecanoic acid (myristic acid), sodium oleate, lauric acid, palmitic acid, and stearic acid; glucose based co-surfactants with an aliphatic carbon tail, such as alkyl glycosides, alkylpolyglucosides, alkyl thio-glycosides, and alkyl maltosides; amphoteric betaines, such as cocamidopropyl betaine (CAPB), and sodium cocoiminodipropionate (CADP); polyethylene glycol sorbitan monolaurate, i.e. tween® (e.g. tween® 20, tween® 80 and tween® 85); and polyoxyethylene lauryl ethers, such as polyethylene glycol dodecyl ether, pentaethylene glycol monododecyl ether and octaethylene glycol monododecyl ether.

Thus, the at least two surfactants used in the cellulose foam preferably comprise a mixture of an anionic surfactant and a co-surfactant. The molar ratio between anionic surfactant to co-surfactant may be from 0.2:1-3:1, preferably from 0.5:1 to 2:1. The total amount of the at least two surfactants together in the cellulose foam may be 0.6-5 wt %, or 0.8-2.0 wt %, as calculated on the total weight of the cellulose foam.

The cellulose foam can be re-dispersed in water and as a result be recyclable in regular paper recycling streams.

The cellulose foam may be prepared using a method comprising the following steps:
disintegrating cellulose fibres in water to obtain a slurry of cellulose fibres;
adding a water-soluble thickener to the slurry to obtain a mixture of thickener and cellulose fibres in water;
adding at least two surfactants to the mixture to obtain a fibre suspension; and
aerating the fibre suspension to obtain a wet foam, wherein the wet foam comprises 10-38 wt % cellulose fibres, 0.5-10 wt % of the water-soluble thickener, and 0.1-2 wt % surfactants, as calculated on the total weight of the wet foam, and wherein the foam has a density of from 140-500 kg/m³ and a yield stress of from 40 to 400 Pa;
drying the wet foam to obtain a solid cellulose foam.

The drying step can be omitted if a solid cellulose foam is not desired. The drying step can also be carried out only until a partially dried cellulose foam is obtained.

Addition of a water-soluble thickener increase the viscosity of the slurry and enables incorporation of enough air to generate a densely packed foam during aeration. Since the cellulose fibres are mixed in high concentrations a drainage step is not needed, which enables the use of a water-soluble bio-based thickener in high concentrations.

Addition of a fast-acting surfactant will contribute to the formation of a cellulose foam with a high density and a high viscosity as it will quickly settle at the air-water interphase during aeration. This enables a free-standing wet cellulose foam. Addition of a co-surfactant along with the fast-acting surfactant will further improve the properties of the cellulose foam since it will facilitate the action of the fast-acting surfactant. A co-surfactant having a suitable pKa and a long carbon chain further contributes to a stable fibre suspension and a stable wet cellulose foam.

Upon aeration the composition comprising cellulose fibres, thickener and at least two surfactants will form a highly stable wet fibre foam. The aeration may be performed by mechanical agitation, and a substantial amount of air is incorporated into the material. The formation of a foam will be promoted by the surfactants. By adjusting the stability of the wet foam with the use of thickeners and surfactant combinations, a free-standing cellulose foam can be made without the use of a cross-linker or fibrillated cellulose. A good stability of the foam prevents ripening, i.e. change in bubble size, and drainage. The obtained wet foam is free-standing and does not require a mould or a forming fabric to retain its shape upon drying. The wet foam can thus be formed into a free-standing foam that is stable enough to be dried in the absence of a supporting mould without collapsing. As a result, objects can be formed and dried without the use of a mould.

The bubble size in the wet foam is typically below 100 μm. This provides for a homogenous wet foam with good stability that does not flocculate during processing. During processing, and also during the subsequent drying step, the average bubble size is maintained to a large extent and the cellulose fibres remain well dispersed. The resulting solid cellulose foam obtained by drying the wet foam will be homogenous in structure, strong, have good mechanical properties, a smooth surface and no defects. A smooth surface may be beneficial when a coating is to be applied on the foam.

In comparison, a wet cellulose foam with low stability has a larger average bubble size (i.e. typically above 100 μm) and the bubbles will coalesce faster during processing and drying such that larger bubbles are formed. In addition, the cellulose fibres will form clusters during processing and drying. This results in the wet foam collapsing during drying. The resulting solid cellulose foam will not have a homogenous structure and will also contain defects in the form of cavities resulting from the coalesced bubbles in the wet foam. Such a solid cellulose foam is, due to the defects, weak and has a rough surface.

Because of the high solid content, the wet foam does not need to be dewatered before it is dried. The foam may be dried by evaporation at room temperature or at an elevated temperature, such as a temperature of from 40-140 °C. The dry cellulose foam may have a density of from 10 to 80 kg/m³, or from 10 to 60 kg/m³, or from 20 to 50 kg/m³.

In preferred embodiments the cellulose foam comprises cellulose fibres in a range of from 71 to 95 wt %, such as from 75 to 95 wt %, based on the total dry weight of the cellulose foam, a water-soluble thickener in a range of from 4 to 24 wt %, such as from 5 to 20 wt %, based on the total dry weight of the cellulose foam, and at least two surfactants. A wet cellulose foam having such a composition is homogenous in structure and has a good stability as discussed above. Such a wet cellulose foam can also be dried without prior dewatering.

The solid cellulose foam may have any shape, such as a block, a cube, a cylinder or any irregular shape. Regardless of the shape, the solid cellulose foam will have at least one outer surface. The term “outer surface” as used herein refers to the outermost surface of the solid cellulose foam. It is not intended to mean the outermost surface of any final foam product. In the present invention, the outer surface of the solid cellulose foam is coated with at least one coating layer. It may further be covered with other layers, such as an additional layer of a cellulose foam.

In one embodiment, the solid cellulose foam is provided in the form of a plank having a thickness in the range of from 1 to 20 cm, preferably from 1 to 10 cm, more preferably from 4 to 6 cm. The length and width dimensions of the plank are typically in the range of from 100 to 300 cm. The planks may be cut into smaller pieces but preferably having the same thickness. In embodiments where the solid cellulose foam is provided in the form of a plank, outer surfaces are thus present on the top surface, the bottom surface and the side surfaces of the plank.

The solid cellulose foam may on at least one outer surface have a densified layer. In embodiments where the cellulose foam is provided in the form of a plank, the cellulose foam has densified layers on at least the top surface and bottom surface, and optionally on the side surfaces.

The densified layer comprises cellulose fibres that are packed more tightly and partly oriented differently compared to the bulk leading to a higher number of fibre-fibre bonds. The densified layer is formed on the outer surface of the wet foam during drying of the wet foam and remain on the outer surface of the solid cellulose foam when dried. The densified layers have improved mechanical stability and strength as compared to the core of the solid cellulose foam. The core of the solid cellulose foam comprises a homogenous open-cell fibre network. The core is highly porous, and even though the densified layer has a denser structure than the core, it is still porous.

The densified layer thus provides the solid cellulose foam with increased stability and mechanical strength. In embodiments where the solid cellulose foam is provided in the form of a plank, it is therefore preferable that during cutting of the foam planks, cutting is carried out such that the thickness of the planks remains the same also after cutting, thus ensuring that the densified layers are still present on the top surface and bottom surface.

According to the first aspect of the present invention, the solid cellulose foam is provided with at least one coating on at least one outer surface. The solid cellulose foam may be provided with a coating on one outer surface, or on several outer surfaces or on all outer surfaces. In embodiments where the solid cellulose foam is provided with a coating on more than one outer surface, the composition of the coating on the coated outer surfaces may be identical or different. For example, the solid cellulose foam may be provided with a first type of coating on a first outer surface and a second type of coating on a second outer surface. It is also within the scope of the present invention to provide more than one coating on the same outer surface, e.g. that a first part of the outer surface may be covered with a first coating and a second part of the outer surface may be covered with a second coating.

In embodiments where the solid cellulose foam is provided in the form of a plank, it may be provided with a coating on the top surface, on the bottom surface and/or on any of the side surfaces.

The coating is preferably provided on an outer surface of the solid cellulose foam comprising a densified layer, since the densified layer is smoother and has a less open structure than an outer surface not comprising a densified layer. In embodiments where not all outer surfaces of the solid cellulose foam comprise densified layers, the coating may be provided both on surfaces comprising the densified layers and on outer surfaces that do not comprise a densified layer.

An adhesive layer may be provided on the at least one outer surface of the cellulose foam, or on the densified layer if present. In such embodiments, the coating is provided on the adhesive layer. Preferably, the coating is provided directly onto the solid cellulose foam, i.e. without the use of an adhesive layer.

The coating comprises at least one coating layer, such as at least two coating layers or at least three coating layers. In embodiments where the coating comprises at least two coating layers, the composition of the at least two coating layers may be identical or different.

In embodiments where the solid cellulose substrate is provided with a coating on more than one outer surface, each coating may comprise at least one coating layer, such as at least two coating layers or at least three coating layers.

The term “composition” as used herein refers to the composition of a coating in terms of its components. Compositions may differ from each other in terms of concentration of the components, or in terms of the components present in the composition, or a combination of both.

The application of a coating on the outer surface of the solid cellulose foam will decrease the air permeability of the solid cellulose foam since pores on the outer surface are closed by the coating. To sufficiently close all pores on the surface, it is important that the coating is sufficiently thick, and the surface of the foam must be relatively flat. In some embodiments, the at least one coating has a basis weight in the range of from 2 to 500 g/m², such as from 2 to 300 g/m², or from 2 to 250 g/m², or from 10 to 200 g/m², or from 10 to 150 g/m², or from 50 to 150 g/m², or from 50 to 300 g/m². By decreasing the air permeability of the cellulose foam by application of at least one coating on at least one outer surface, use of the resulting coated solid cellulose foam material in automated processes involving vacuum is greatly facilitated. The coated solid cellulose foam may for example be used in converting and packaging processes involving steps requiring vacuum lifting and fixation.

Since the coating is thin, it has a negligible effect on the density of the coated solid cellulose material. Thus, the density of the coated solid cellulose material is also within the range of from 10 to 80 kg/m³, or from 10 to 60 kg/m³, or from 20 to 50 kg/m³.

The coating is provided by application of at least one layer of at least one coating composition to the at least one outer surface of the cellulose foam. The coating composition is preferably a liquid, such as a water-based suspension or dispersion.

In some embodiments, the coating may comprise at least one particulate material. The particulate material may be selected from at least one of microfibrillated cellulose (MFC), cellulose fibres, mineral particles such as clay or calcium carbonate. Depending on the type of particulate material, the properties of the coating may be improved by addition of a film-forming material. Some particulate materials, such as MFC, does not require the addition of a film-forming material to the coating.

The coating may comprise at least one particulate material and at least one film-forming material. A coating comprising at least one particulate material and at least one film-forming material will increase the coverage of the coating on the outer surface of the cellulose foam and thus decrease the risk of formation of pin holes, which if present would negatively influence the air permeability of the cellulose foam. In addition, the smoothness and gloss of the coated solid cellulose foam material may be improved. Further, the ink absorbency may be improved by providing a coating, thus allowing for improved printability in terms of a higher definition printing, since ink will not bleed into the coated solid cellulose foam material.

The coating composition may comprise at least one particulate material and at least one film-forming material. For example, the coating composition may comprise a particulate material, a film-forming material, optionally at least one additive, and water.

The particulate material may be selected from at least one of microfibrillated cellulose (MFC), cellulose fibres, mineral particles such as clay or calcium carbonate.

The film-forming material may be selected from at least one of carboxymethyl cellulose (CMC), cellulose ethers, starch, polyvinyl alcohol or synthetic latexes, such as acrylic or styrene-butadiene latexes.

For example, the coating may comprise CMC, calcium carbonate and glycerol (acting as a plasticizer). The corresponding coating composition comprises CMC, calcium carbonate, glycerol and water.

In one embodiment, the coating comprises MFC. The corresponding coating composition comprises MFC and water. Microfibrillated cellulose (MFC) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

A coating comprising MFC will have excellent strength properties as well as a good coverage of pores in the solid cellulose foam, thus providing the coated solid cellulose foam with an improved strength as well as a decreased air permeability. In addition, a coating based on MFC is of advantage when it comes to recycling of the coated cellulose foam material. MFC may in some embodiments act both as a particulate material and a film-forming material. For example, the coating may consist entirely of MFC. In another example, the coating comprises MFC, CMC and a plasticizer, such as glycerol. The corresponding coating compositions used for providing the coatings would comprise MFC and water; and MFC, CMC, plasticizer, and water respectively.

In one embodiment, the coating comprises cellulose fibres. The corresponding coating composition comprises cellulose fibres. The cellulose fibres may be selected from wood pulp; regenerated cellulose fibres; and plant fibres, such as fibres from bamboo, cotton, hemp, flax, and jute. Preferably, the cellulose fibres are selected from wood pulp, such as softwood pulp, hardwood pulp, chemical-thermomechanical pulp, and from dissolving pulp, or a combination of one or more of these.

A coating comprising cellulose fibres may have a good coverage of pores in the solid cellulose foam. For example, the coating may comprise cellulose fibres and various additives typically used in paper manufacturing. The corresponding coating composition used for providing the coating would comprise cellulose fibres, additives and water. Depending on the additives used, a film-forming material may or may not be needed in the coating and in the coating composition.

The coating may optionally comprise at least one additive, such as dispersants, de-foamers, UV-absorbers, plasticizers, wet-resistance additives and strength additives. Addition of at least one additive to the coating will provide the coating with improved properties. Any suitable additives can be added, examples of additives are glycerol and polyethylene glycol (PEG).

In one embodiment, the coating comprises at least one hydrophobic agent. The corresponding coating composition comprises at least one hydrophobic agent. The hydrophobic agent may be selected from at least one of a wax, such as bee's wax or carnauba, alkyl ketene dimer (AKD) or alkyl succinic anhydride (ASA). In some embodiments, the coating may comprise a hydrophobic agent as well as a particulate material and a film-forming material. In such embodiments, the hydrophobic agent may be part of the same coating layer as the particulate material and the film-forming material, or it may form a different coating layer.

The coating composition comprising at least one hydrophobic agent may be a water-based emulsion, or it may be a solution comprising the hydrophobic agent and at least one solvent, such as an alcohol.

The at least one hydrophobic agent provides hydrophobic properties to the coating. This is of particular importance in applications where improved water resistance is required, such as when using the coated solid cellulose foam material in thermal packaging solutions where condensation may pose a problem.

In embodiments where the coating comprises at least two coating layers, the composition of the at least two coating layers may be identical or different. For example, two or more coating layers of the same coating composition may be applied to the cellulose foam, such as two layers of a coating composition comprising MFC. In another example, two coating layers of different coating compositions may be applied to the cellulose foam, such as a first coating layer of a coating composition comprising MFC and a second coating layer of a coating composition comprising a hydrophobic agent. If a coated solid cellulose material having improved water resistance is required, it is advantageous to have an outermost coating layer that comprises a hydrophobic agent.

In embodiments where the coating comprises at least two coating layers, the first coating layer is applied to the outer surface of the cellulose foam, and the second coating layer is applied on top of the first coating layer, and so on.

In embodiments where at least two outer surfaces of the solid cellulose foam are provided with a coating, the at least two coatings may be identical or different. For example, one or more coating layers of a coating composition comprising MFC may be applied on all outer surfaces of a solid cellulose foam. In another example, one or more coating layers of a coating composition comprising MFC may be applied on a first outer surface of a cellulose foam, and a coating composition comprising a hydrophobic agent may be applied on a second outer surface of said cellulose foam.

In some embodiments an additional layer of material, such as a fibrous substrate or a second cellulose foam, is applied on top of the at least one coating, so that the coating is sandwiched between the cellulose foam and the additional layer of material. At least one coating may be applied also on at least one outer surface of the additional layer of material.

In some embodiments, the solid cellulose foam may be prepared by a two-step deposition. In a first deposition, a wet foam is deposited as discrete units on a surface and at least partially dried. During drying, a densified layer is formed on the outer surface of the discrete units. In a second deposition a wet foam, preferably having the same composition as the wet foam in the first deposition, is deposited so that it fills the spaces surrounding the discrete units of the first deposition. After drying, a solid cellulose foam comprising discrete units of foam embedded in a foam matrix is obtained. The densified layer on the outer surface of the discrete units provides mechanical support during drying of the foam in the second deposition and the entire cellulose foam by helping to keep the shape of the discrete units. A coating may be applied to at least one outer surface of the solid cellulose foam comprising discrete units of foam embedded in a foam matrix. A coating may also be applied to the outer surface of the discrete units, prior to depositing the second deposition. The coating is applied to the outer surface of the discrete units when the discrete units have been at least partially dried, so that the outer surface of the discrete units comprises a densified layer when the coating is applied. In one example, a coating composition comprising MFC is applied to an outer surface of the at least partially dried discrete units, and a coating composition comprising a hydrophobic agent is applied to an outer surface of the solid cellulose foam comprising discrete units embedded in a foam matrix, i.e. after the second deposition.

By selection of what type of coating(s) to apply on a cellulose foam, the properties of the obtained coated solid cellulose foam material can be carefully tailored.

The coating may be applied to the entire at least one outer surface of the cellulose foam, or only to one or more regions of the at least one outer surface of the cellulose foam. Thus, the at least one outer surface of the coated solid cellulose foam may be completely covered by the at least one coating, or the at least one outer surface of the coated solid cellulose foam may be partly covered by the at least one coating. For example, the coating may be applied in a pattern such that the outer surface comprises coated regions and uncoated regions.

In some embodiments, the at least one coating is applied in a pattern adapted to type of vacuum equipment to be used in converting operations. For example, the at least one coating may be applied in places where vacuum suction is to be applied, such that the air permeability of the cellulose foam is decreased mainly at the coated regions.

In embodiments where the coating comprises at least two coating layers, the at least two coating layers may cover different regions of the outer surface, or may cover the same regions. For example, the at least two coating layers may be applied in different patterns on the outer surface. In one example, one coating layer is applied such that it covers the entire at least one outer surface, and a second coating layer is applied in a pattern on top of the first coating layer. The composition of the at least two coating layers may be the same or may be different.

In embodiments where a coating is applied to more than one outer surface of the cellulose foam, the coating layers may be applied in the same pattern, or in different patterns, to the at least two outer surfaces.

According to a second aspect, the present invention relates to a method for coating a cellulose foam. Step a) of the method according to the second aspect involves providing a cellulose foam comprising at least one outer surface. The cellulose foam provided in step a) is at least partially dry. In the context of the present invention, at least partially dry means that at least the outer surface of the cellulose foam is dry, so that a coating can be applied on it. In a preferred embodiment, the provided cellulose foam is dry and may have a solid content in the range of from 95 to 100 wt %, preferably from 98 to 100 wt %, as calculated on the total weight of the cellulose foam. Thus, preferably a solid cellulose foam is provided in step a). The density of the solid cellulose foam may be in the range of from 10 to 80 kg/m³, such as from 10 to 60 kg/m³, or from 20 to 50 kg/m³. The cellulose foam may be further defined as set out above with reference to the first aspect.

Step b) of the method according to the second aspect involves providing at least one coating composition. The coating composition is preferably a liquid, such as an aqueous dispersion, suspension or emulsion. Other suitable solvents than water may also be used. The coating composition may be further defined as set out above with reference to the first aspect.

Step c) of the method according to the second aspect involves applying at least one coating layer of the at least one coating composition to at least one outer surface of the cellulose foam so as to obtain a coated cellulose foam material. The coating composition may be applied using any suitable method used for coating such as roller coating, blade/knife coating, brushing, flexo roller, and spray coating. In embodiments where more than one coating layer is applied, the coating compositions of the respective coating layers may be applied using the same coating method, or different ones. Different combinations of coating layers may be applied depending on the desired properties of the coated cellulose foam material, as further set out above with reference to the first aspect.

The coating layer may be applied to the entire at least one outer surface, or only to some regions of the at least one outer surface, as further set out above with reference to the first aspect.

Step d) of the method according to the second aspect involves drying the coated cellulose foam material so as to obtain a coated solid cellulose foam material having a density in the range of from 10 to 80 kg/m³, such as from 10 to 60 kg/m³, or from 20 to 50 kg/m³. The coated cellulose foam material may be dried by evaporation at room temperature or at an elevated temperature, such as a temperature of from 40 to 140 °C. Any suitable drying equipment, such as an oven, or infrared heating, may be used.

In embodiments where at least two coating layers are applied, the first coating layer may be dried before application of the second coating layer. If a third coating layer is to be applied, the second coating layer may be dried before application of the third layer, and so on. In an alternative embodiment, the first coating layer is not dried before application of the second coating layer.

### Examples

### Example 1—Preparation of Foam

A uniform wet paste comprising 12 wt % cellulose pulp (softwood bleached Kraft pulp) and a 1.2 wt % thickener (CMC) in water was prepared. The wet paste was aerated with a surfactant mixture (myristic acid and sodium cocoyl sarcosinate) until a desired wet foam density was obtained. A cylindrical mould with the dimension of 2.5 cm in height and 6.6 cm in diameter were used to deposit discrete units of the foam on a flat surface. The moulds were used only for depositing the wet foam in the desired shape and dimension and were removed before the foam was dried.

The shaped foam was dried in an ordinary convection oven at 120 °C until completely dry. The dry cellulose foam had a density of 30 kg/m³.

### Example 2

A cylindrical dry cellulose foam prepared as described for example 1 was coated with an aqueous solution comprising microfibrillated cellulose (2 wt %). The coating was applied on all sides of the cellulose foam using a brush and ensuring that the applied coating layer was thick enough to cover the surface of the foam. The MFC-coating was applied on the densified layers on the outer surfaces of the foam.

The air permeability of the cellulose foam was reduced by the MFC-coating. In addition, the smoothness of the surface of the foam was improved by the coating.

Further, the strength of the densified layer was improved by the coating. This was evident as the properties during impact testing was better than for a foam without an MFC-coating. The degradation over time was also less for the foam with an MFC-coating compared to a foam with no coating. Comparisons are made with a foam according to example 1.

### Example 3

A cylindrical dry cellulose foam prepared as described in example 1 was coated with an aqueous coating comprising CaCO₃ and CMC. The coating solution was prepared by dispersing calcium carbonate in an 8% (w/w) aqueous CMC solution such that the final solid content was 40% (w/w). The coating was applied on all sides of the foam using a brush and ensuring that the applied coating layer was thick enough to cover the surface of the foam. The coated foams were dried in an oven at 120 °C until completely dry

The air permeability of the cellulose foam was reduced by the coating, and it was evident that the coating blocked pores on the surface, and the air permeability was decreased. It was also evident that the surface of the foam became smoother after application of the coating.

### Example 4

The same as example 3, but with the addition of glycerol (8 w/w) to the CMC coating solution. The coating was improved by addition of glycerol, further reducing the air permeability of the cellulose foam after application of the coating as compared to the coating in example 3.

### Example 5

A uniform wet paste comprising 12 wt % cellulose pulp (softwood bleached Kraft pulp) and 1.2 wt % thickener (CMC) in water was prepared. The wet paste was aerated with a surfactant mixture (myristic acid and sodium cocoyl sarcosinate) until a desired wet foam density was obtained. A mould of 27*37*5 cm was filled with the aerated wet foam and the surface was scraped to remove any extra foam and to level the surface to the height of the frame. Finally, the foam was dried in an ordinary convection oven at 120 °C until completely dry. The dry cellulose foam had a density of 30 kg/m³.

The coating solution was prepared by dispersing calcium carbonate (24% (w/w)), PEG (0.8% (w/w)) and glycerol (23.25% (w/w)) in an aqueous CMC solution such that the final solid content was 52% (w/w). PEG and glycerol act as plasticizers.

The coating was applied on the top side of the foam and only on one quarter of the surface using a brush and ensuring that the applied coating layer was thick enough to cover the surface of the foam. The coated foam was dried in an oven at 120 °C until completely dry.

The air permeability of the cellulose foam was greatly reduced by the coating on the coated area of the foam. The effectiveness of the coating was tested by using vacuum suction to lift the foam plank. When applying the vacuum suction cup to the area of the foam that was not coated, not enough suction effect was achieved, and the foam plank could not be lifted. However, when the vacuum suction cup was used on the coated area of the foam the plank could be lifted.

In view of the above detailed description of the present invention, other modifications and variations will become apparent to those skilled in the art. However, it should be apparent that such other modifications and variations may be effected without departing from the spirit and scope of the invention.

1. A coated solid cellulose foam material having a density in the range of from 10 to 80 kg/m³, and wherein the coated cellulose foam material comprises:
a solid cellulose foam having at least one coating on at least one outer surface, and wherein the at least one coating comprises at least one coating layer.

2. The coated solid cellulose foam material according to claim 1, wherein the solid cellulose foam comprises cellulose fibres in a range of from 71 to 95 wt % based on a total dry weight of the solid cellulose foam.

3. The coated solid cellulose foam material according to claim 1, wherein the solid cellulose foam comprises:
cellulose fibres in a range of from 71 to 95 wt % based on a total dry weight of the solid cellulose foam,
a water-soluble thickener in a range of from 4 to 24 wt % based on the total dry weight of the solid cellulose foam, and
at least two surfactants.

4. The coated solid cellulose foam material according to claim 1, wherein the at least one outer surface of the solid cellulose foam comprises a densified layer.

5. The coated solid cellulose foam material according to claim 4, wherein the at least one coating is provided on the densified layer.

6. The coated solid cellulose foam material according claim 1, wherein the at least one coating comprises at least two coating layers, and
wherein compositions of each of the at least two coating layers are different.

7. The coated solid cellulose foam material according to claim 1, wherein the at least one coating comprises at least one particulate material and at least one film-forming material.

8. The coated solid cellulose foam material according to claim 1, wherein the at least one coating comprises microfibrillated cellulose (MFC).

9. The coated solid cellulose foam material according to claim 1, wherein the at least one coating comprises at least one hydrophobic agent.

10. The coated solid cellulose foam substrate according to claim 1, wherein the at least one coating has a basis weight in the a range of from 2 to 300 g/m².

11. A method for coating a cellulose foam, the method comprising the following steps:
a) providing a cellulose foam comprising at least one outer surface, and wherein the at least one outer surface is at least partially dry;
b) providing at least one coating composition;
c) applying at least one coating layer of the at least one coating composition to at least one outer surface of the cellulose foam so as to obtain a coated cellulose foam material;
d) drying the coated cellulose foam material so as to obtain a coated solid cellulose foam material having a density in the a range of from 10 to 80 kg/m³.

12. The method according to claim 11, wherein the cellulose foam comprises cellulose fibres in a range of from 71 to 95 wt % based on a total dry weight of the cellulose foam.

13. The method according to claim 11, wherein the cellulose foam comprises:
cellulose fibres in a range of from 71 to 95 wt % based on a total dry weight of the cellulose foam,
a water-soluble thickener in a range of from 4 to 24 wt % based on the total dry weight of the cellulose foam, and
at least two surfactants.

14. The method according to claim 11, wherein the at least one coating composition comprises a liquid.

15. The method according to claim 11, wherein at least two coating layers are applied, and
wherein coating compositions of each of the at least two coating layers are different.

16. The method according to claim 11, wherein the cellulose foam is a solid cellulose foam, having a density in a range of from 10 to 80 kg/m³.

17. The method according to claim 11, wherein the at least one coating composition comprises at least one particulate material and at least one film-forming material.

18. The method according to claim 11, wherein the at least one coating composition comprises MFC.

19. The method according to claim 11, wherein the at least one coating composition comprises at least one hydrophobic agent.

20. (canceled)
